(19) United States
(12) Patent Application Publication
(10) Pub. No.: US 2024/0075547 A1
(43) Pub. Date: Mar. 7, 2024

(54) WELDING-TYPE SYSTEMS WITH EMPTY WIRE SPOOL DETECTION CAPABILITIES

(71) Applicant: Illinois Tool Works Inc., Glenview, IL (US)

(72) Inventor: Maxwell Bode Brock, Appleton, WI (US)

(21) Appl. No.: 18/225,257

(22) Filed: Jul. 24, 2023

Related U.S. Application Data
(60) Provisional application No. 63/403,343, filed on Sep. 2, 2022.

(51) Int. Cl. B23K 9/12

(52) U.S. Cl. CPC B23K 9/125

(57) ABSTRACT

Systems and methods are disclosed relating to welding-type systems that automatically detect when a wire spool is emptied of welding wire. This may help to alert an operator to an issue that might negatively impact the welding-type operation. Additionally, the systems detect when the wire spool is emptied of welding wire using wire feeder parameters that are already relied upon for control and/or protection of the wire feeder, thereby omitting the need for extra (and/or expensive) components.

### CROSS REFERENCE TO RELATED APPLICATIONS

This application claims priority to, and the benefit of, U.S. Provisional Application No. 63/403,343 entitled “Welding-Type Systems with Empty Wire Spool Detection Capabilities,” filed Sep. 2, 2022, the entire contents of which are hereby incorporated by reference.

### TECHNICAL FIELD

This disclosure relates to welding-type systems and, more particularly, to welding-type systems with empty wire spool detection capabilities.

### BACKGROUND

Some welding-type systems use consumable filler material, such as electrode welding wire, to conduct welding-type operations. In some instances, the welding material is stored in a coil on a wire spool and retained within a housing of a wire feeder. The welding wire may be fed to a welding-type operation from the spool, via the feeder, until the welding-type operation is complete, or the welding wire is completely consumed.

### SUMMARY

Welding-type systems with empty wire spool detection capabilities are disclosed, substantially as illustrated by and described in connection with at least one of the figures, as set forth more completely in the claims.

These and other advantages, aspects, and/or novel features of the present disclosure, as well as details of an illustrated example thereof, will be more fully understood from the following description and drawings.

### DRAWINGS

Features, aspects, and/or advantages of the present disclosure will become better understood when the following detailed description is read with reference to the accompanying drawings in which like characters represent like parts throughout the drawings, wherein:

FIG. 1 shows an example of a welding-type system, in accordance with aspects of this disclosure.

FIG. 2 is a block diagram showing components of the welding-type system of FIG. 1, in accordance with aspects of this disclosure.

FIG. 3 is a block diagram showing certain components of the welding-type system of FIG. 2 in more detail, in accordance with aspects of this disclosure.

FIG. 4 is a flow diagram illustrating an example empty spool detection process, in accordance with aspects of this disclosure.

The figures are not necessarily to scale. Where appropriate, similar or identical reference numbers are used to refer to similar or identical components. For example, reference numerals utilizing lettering (e.g., first summing module 316a, second summing module 316b) refer to instances of the same reference numeral that does not have the lettering (e.g., summing modules 316).

### DETAILED DESCRIPTION

Some examples of the present disclosure relate to welding systems with the ability to monitor certain parameters of a wire feeder, and alert an operator when one or more of the parameters indicate that a wire spool in the wire feeder is empty of welding wire. This may help alert an operator to a potential issue, as a sudden loss of welding wire during a welding process can negatively impact the welding process. Such an alert may be particularly helpful in push/pull systems, where additional “pull” feed rollers in the welding tool may continue feeding welding wire even when the wire spool is out of welding wire. The wire feeder parameter(s) monitored by the disclosed welding-type systems (to determine when the wire feeder is empty of welding wire) are also already present and used for other purposes in the wire feeder (e.g., motor control/protection), so no additional (and/or expensive) components are required.

Some examples of the present disclosure relate to a welding system, comprising: a wire feeder, comprising: a spindle configured to retain a wire spool, a feed roller configured to pull a welding wire from the wire spool and feed the welding wire to a welding tool during a welding operation, and a feed motor configured to rotate the feed roller; and control circuitry configured to: monitor a current magnitude of an electrical current supplied to the feed motor, a current magnitude rate of change of the current magnitude, an error signal magnitude of an error signal used to control the electrical current supplied to the feed motor, or an error signal magnitude rate of change of the error signal magnitude, compare the current magnitude, the current magnitude rate of change, the error signal magnitude, or the error signal magnitude rate of change to a threshold, and in response to the current magnitude, or the current magnitude rate of change, falling below the threshold, or the error signal magnitude, or the error signal magnitude rate of change, rising above the threshold, output a notification or disable the welding operation.

In some examples, the notification indicates that the welding wire has run out, and the notification is delivered via an interface of: the wire feeder, a welding-type power supply in communication with the wire feeder, the welding tool, or a remote device in communication with the wire feeder or the welding-type power supply. In some examples, the control circuitry is further configured to: monitor the current magnitude, or the error signal magnitude rate of change, over a time period of the welding operation or a prior welding operation, identify a representative electrical current, or a representative rate of change of the error signal, based on the current magnitude, or the error signal magnitude rate of change, monitored over the time period, and determine the threshold based on the representative electrical current or the representative rate of change of the error signal. In some examples, the control circuitry is configured to control the electrical current supplied to the feed motor based on a target wire feed speed and the error signal.

In some examples, the control circuitry is configured to determine the threshold based on the target wire feed speed. In some examples, the control circuitry is configured to control the electrical current supplied to the feed motor based on a target wire feed speed and the error signal, the error signal being generated based on the target wire feed speed and a feedback signal. In some examples monitoring the current magnitude of the electrical current supplied to the feed motor comprises monitoring a duty cycle of a pulse width modulation (PWM) signal used to control the electrical current supplied to the feed motor, or monitoring the current magnitude rate of change comprises monitoring a duty cycle rate of change of the duty cycle.

In some examples, the control circuitry is configured to monitor the current magnitude of the electrical current supplied to the feed motor using a low pass filtered version of a motor current feedback signal, and output the notification or disable the welding operation in response to the current magnitude falling below the threshold. In some examples, the control circuitry is further configured to: identify a representative electrical current supplied to the feed motor using the low pass filtered version of the motor current feedback signal, and determine the threshold based on the representative electrical current. In some examples, the control circuitry is configured to monitor the error signal magnitude, and output the notification or disable the welding operation in response to the error signal magnitude rising above the threshold.

Some examples of the present disclosure relate to a method, comprising: retaining a wire spool on a spindle of a wire feeder; rotating a feed roller of the wire feeder, via a feed motor of the wire feeder; pulling a welding wire from the wire spool and feeding the welding wire to a welding tool during a welding operation, via the feed roller; monitoring, via control circuitry, a current magnitude of an electrical current supplied to the feed motor, a current magnitude rate of change of the current magnitude, an error signal magnitude of an error signal used to control the electrical current supplied to the feed motor, or an error signal magnitude rate of change of the error signal magnitude; comparing the current magnitude, the current magnitude rate of change, the error signal magnitude, or the error signal magnitude rate of change to a threshold, via the control circuitry; and in response to the current magnitude, or the current magnitude rate of change, falling below the threshold, or the error signal magnitude, or the error signal magnitude rate of change, rising above the threshold, outputting a notification or disabling the welding operation, via the control circuitry.

In some examples, the notification indicates that the welding wire has run out, and the notification is delivered via an interface of: the wire feeder, a welding-type power supply in communication with the wire feeder, the welding tool, or a remote device in communication with the wire feeder or the welding-type power supply. In some examples, the method further comprises: monitoring, via the control circuitry, the current magnitude, or the error signal magnitude rate of change, over a time period of the welding operation or a prior welding operation; identifying, via the control circuitry, a representative electrical current, or a representative rate of change of the error signal, based on the current magnitude, or the error signal magnitude rate of change, monitored over the time period, and determining, via the control circuitry, the threshold based on the representative electrical current or the representative rate of change of the error signal. In some examples, the method further comprises controlling, via the control circuitry, the electrical current supplied to the feed motor based on a target wire feed speed and the error signal.

In some examples, the method further comprises determining, via the control circuitry, the threshold based on the target wire feed speed. In some examples, the method further comprises controlling, via the control circuitry, the electrical current supplied to the feed motor based on a target wire feed speed and the error signal, the error signal being generated based on the target wire feed speed and a feedback signal. In some examples, monitoring the current magnitude of the electrical current supplied to the feed motor comprises monitoring a duty cycle of a pulse width modulation (PWM) signal used to control the electrical current supplied to the feed motor, or monitoring the current magnitude rate of change comprises monitoring a duty cycle rate of change of the duty cycle.

In some examples, the current magnitude of the electrical current supplied to the feed motor, or the current magnitude rate of change, is monitored using a low pass filtered version of a motor current feedback signal, and the notification is output, or the welding operation disabled, in response to the current magnitude or the current magnitude rate of change falling below the threshold. In some examples, the control circuitry monitors the current magnitude rate of change, and outputs the notification or disables the welding operation in response to the current magnitude rate of change falling below the threshold. In some examples, the control circuitry monitors the error signal magnitude rate of change, and outputs the notification or disables the welding operation in response to the error signal magnitude rate of change rising above the threshold.

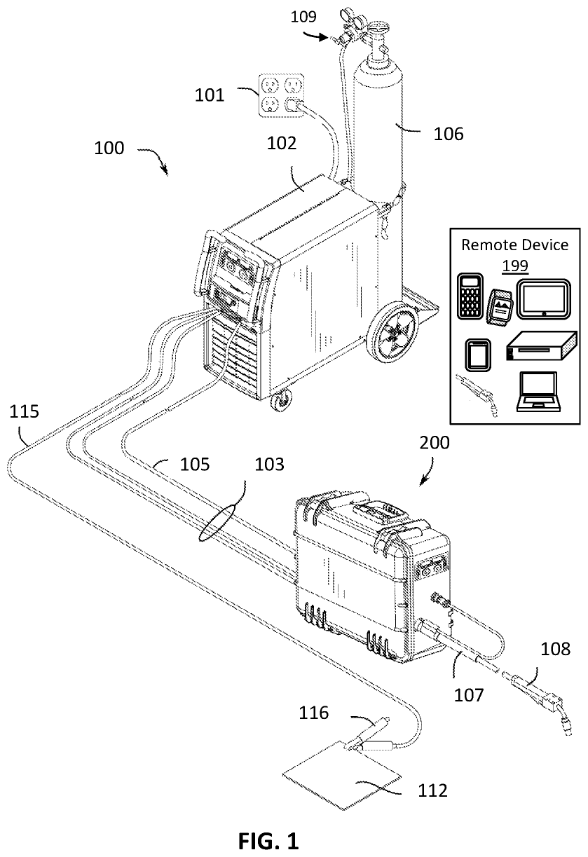

FIG. 1 shows an example of a welding-type system 100, such as may be used to conduct welding-type operations (e.g., welding, cutting, brazing, etc.). In some examples, the example welding-type system 100 shown in FIG. 1 may be used to conduct gas metal arc welding (GMAW) processes. In some examples, the welding-type system 100 may also be used with other arc welding processes (e.g., flux-cored arc welding (FCAW), gas shielded flux-cored arc welding (FCAW-G), gas tungsten arc welding (GTAW), submerged arc welding (SAW), shielded metal arc welding (SMAW), or similar arc welding processes). In some examples, the welding-type system 100 may be used with metal fabrication systems, such as plasma cutting systems, induction heating systems, and so forth. As shown, the welding-type system 100 includes a welding-type power supply 102, a wire feeder 200, a gas tank 106, a welding-type tool 108, and a remote device 199.

In some examples, the remote device 199 may comprise a device configured to communicate, process, receive, and/or output information. In some examples, the remote device 199 may comprise one or more of a computer server, desktop computer, laptop computer, tablet computer, smartphone, smart watch (and/or other smart accessory), pendant, and/or the welding-type tool 108. In some examples, the welding-type power supply 102 and/or wire feeder 200 may send information to, and/or receive information from, the remote device 199 (e.g., information relating to the welding-type system 100 and/or welding-type operations).

In the example of FIG. 1, the welding-type power supply 102 receives input power from a primary power source 101 (e.g., a mains power outlet). In some examples, the welding-type power supply 102 converts the input power to welding-type output power that is used by various welding-type components and/or accessories of the welding-type system 100 (e.g., the wire feeder 200 and/or welding-type tool 108). In some examples, the welding-type power supply 102 may also convert the input power to auxiliary power, which may be used, for example, to power the components of the welding-type power supply 102 and/or wire feeder 200, and/or external devices connected to the welding-type power supply 102 and/or wire feeder 200.

In the example of FIG. 1, the welding-type power supply 102 is coupled to a work clamp 116 through line 115. The work clamp 116 holds a workpiece 112 that may be worked upon during a welding-type operation. As shown, the welding-type power supply 102 is also coupled to the gas tank 106 (e.g., through gas regulator 109). In the example of FIG. 1, the welding-type power supply 102 is further coupled to the wire feeder 200 through cables 103 (including gas hose 105), while the wire feeder 200 is in turn coupled to the welding-type tool 108 through a conduit 107.

In some examples, welding-type power from the welding-type power supply 102 and/or gas from the gas tank 106 may be delivered to the welding-type tool 108 through the conduit 107. In some examples, welding wire (a.k.a. filler material) from the wire feeder 200 may also be supplied to the welding-type tool 108 via conduit 107. In some examples, information from the tool 108 may be provided to the wire feeder 200 through the conduit 107. For example, a trigger signal may be sent through the conduit 107 to the wire feeder when an operator engages a trigger of the tool 108. In some examples, welding-type power, gas, and/or welding wire may be provided to the tool 108, through the conduit, in response to the trigger signal from the tool 108.

In some examples, the welding-type tool 108 may provide welding-type output power to the electrode welding wire to generating an electrical welding arc between the welding wire and the workpiece 112. In some examples, the welding wire may be melted by the arc and/or used to “fill” a weld created by the arc during a welding operation. Because the welding wire is continuously consumed during the welding operation, new welding wire must be constantly fed to the welding-type tool 108 (e.g., by the wire feeder 200) in order for the welding operation to continue.

Additionally, the speed at which the welding wire is fed to the welding-type tool 108 can be important. A sudden loss of welding wire during a welding process can disrupt speed regulation of the welding wire, and thereby negatively impact the welding process. Thus, it can be important for an operator to ensure an adequate supply of welding wire is available in the welding-type system 100.

While shown as separate from the welding-type power supply 102 in the example of FIG. 1, in some examples the wire feeder 200 may be part of the welding-type power supply 102. Likewise, in some examples, the welding-type power supply 102 may instead directly couple to the welding-type tool 108, such that power, welding wire, and/or gas may be directly transmitted to the welding-type tool 108 from the power supply 102. While the welding-type tool 108 is depicted as a metal inert gas (MIG) welding gun in the example of FIG. 1, in some examples, the tool 108 may be some other welding-type tool.

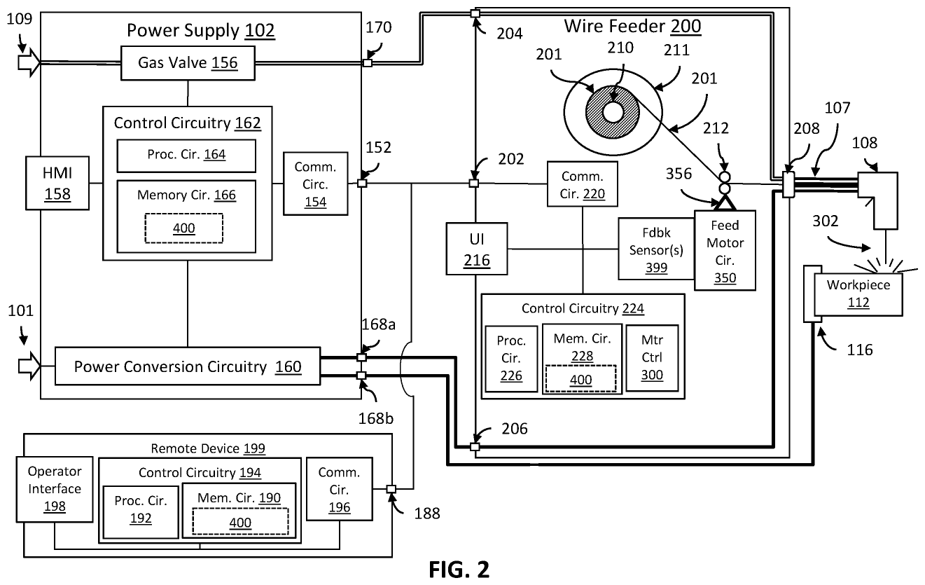

FIG. 2 is a block diagram showing detailed components of certain devices in the welding-type system 100. For example, FIG. 2 depicts the remote device 199 as including an operator interface (OI) 198, device communication circuitry 196, and device control circuitry 194 interlinked through a common electrical bus. Though not shown in the example of FIG. 2, in some examples, the remote device 199 may also include one or more power sources (e.g., batteries, power circuitry, etc.).

In some examples, the OI 198 may comprise user accessible input and/or output devices. For example, the OI 198 may comprise one or more visual output devices (e.g., touch display screens, video monitors, lights, etc.), one or more haptic output devices (e.g., vibration devices), and/or one or more audio output devices (e.g., audio speakers). In some examples, the OI 198 may further comprise one or more input devices (e.g., touch display screens, buttons, knobs, switches, microphones, etc.). In some examples, the OI 198 may comprise one or more input and/or output ports and/or other devices (e.g., universal serial bus (USB) ports, audio ports, HDMI ports, disc drives, compact disc (CD) drives, digital video disc (DVD) drives, etc.). In some examples where the remote device 199 is a computer server, the OI 198 may be a different remote device 199.

In the example of FIG. 2, the device control circuitry 194 includes device processing circuitry 192 and device memory circuitry 190. In some examples, the device control circuitry 194 may be configured to process inputs from the OI 198 and/or device communication circuitry 196, and/or control operation of the OI 198 and/or device communication circuitry 196. In some examples, the device processing circuitry 192 may include one or more processors.

In some examples, the device memory circuitry 190 may store machine readable instructions configured for execution by the device processing circuitry 192 and/or one or more processors. As shown, the device memory circuitry 190 includes an empty spool detection process 400, discussed further below. In some examples, the empty spool detection process 400 may comprise machine readable instructions. While shown as part of the device memory circuitry 190, in some examples, the empty spool detection process 400 may instead (or additionally) be implemented via discrete circuitry of the control circuitry 194.

In the example of FIG. 2, the remote device 199 further includes a device communication terminal 188 interlinked with the device communication circuitry 196. In some examples, the device communication terminal 188 may be part of the device communication circuitry 196. In some examples, the device communication circuitry 196 may be configured to facilitate communication (e.g., through the device communication terminal 188) via one or more wired protocols and/or wireless protocols. Wired protocols may include, for example, USB, Ethernet, serial, and/or other appropriate wired protocols. Wireless protocols may include, for example, cellular protocols, IEEE 802.11 standard protocols (commonly referred to as WiFi), short wavelength ultra-high frequency protocols (commonly referred to as Bluetooth), IEEE 802.15.4 standard protocols (commonly referred to as Zigbee), NFC protocols, RFID protocols, and/or other appropriate wireless protocols. In some examples, the device control circuitry 194 may include one or more driving circuits (and/or processes) for the device communication circuitry 196 and/or OI 198.

In the example of FIG. 2, the device communication terminal 188 is electrically connected to a power communication terminal 152 of the power supply 102 and a feeder communication terminal 202 of the wire feeder 200. While a wired connection is shown in the example of FIG. 2 for the sake of explanation and understanding, in some examples, the connection may be via a wireless connection. In such an example, the device communication terminal 188, power communication terminal 152, and/or feeder communication terminal 202 may comprise one or more antennas to facilitate the wireless communication.

In the example of FIG. 2, the power supply 102 includes the power communication terminal 152, power communication circuitry 154, a gas valve 156, a human machine interface (HMI) 158, power conversion circuitry 160, and power control circuitry 162. As shown, the power communication terminal 152 is connected with the power communication circuitry 154. In some examples, the power communication circuitry 154 may be configured to facilitate communication (e.g., through the power communication terminal 152) via one or more wired protocols and/or wireless protocols, similar to what is described above with respect to the device communication circuitry 196. In some examples, the HMI 158 may comprise user accessible input devices and/or output devices similar (or identical) to what is described above with respect to the OI 198.

In the example of FIG. 2, the power control circuitry 162 is connected to the power communication circuitry 154, gas valve 156, HMI 158, and power conversion circuitry 160. In some examples, the power control circuitry 162 may be configured to process inputs from the HMI 158 and/or power communication circuitry 154, and/or control operation of the HMI 158, power communication circuitry 154, gas valve 156, and/or power conversion circuitry 160.

In the example of FIG. 2, the power control circuitry 162 includes power processing circuitry 164 and power memory circuitry 166. In some examples, the power processing circuitry 164 may include one or more processors. In some examples, the power memory circuitry 166 may store machine readable instructions configured for execution by the power processing circuitry 164 and/or one or more processors. As shown, the power memory circuitry 166 includes an empty spool detection process 400, discussed further below.

In some examples, the power control circuitry 162 may be configured to control operation of the power conversion circuitry 160. In the example of FIG. 2, the power conversion circuitry 160 receives input power from a primary power source 101 (represented in FIG. 2 by arrow 101). In some examples, the power conversion circuitry 160 may be configured to convert the input power received from the primary power source 101 to welding-type power (and/or auxiliary power). In the example of FIG. 2, the power conversion circuitry 160 outputs welding-type power to clamp 116 via power output terminal 168a, and outputs welding-type power to the wire feeder 200 via power output terminal 168b.

In some examples, the power conversion circuitry 160 may include one or more rectifier circuits, pre-regulator circuits, and/or inverter circuits to conduct the conversion of the input power to welding-type power (and/or auxiliary power). In some examples, the power conversion circuitry 160 may include one or more transformers, inductors, capacitors, resistors, diodes, and/or other circuit components to facilitate the conversion. In some examples, the power conversion circuitry 160 may include one or more controllable circuit elements, such as, for example, transistors, switches, and/or relays. In some examples, the power control circuitry 162 may be configured to control the conversion process of the power conversion circuitry 160 by controlling one or more of the controllable circuit elements via one or more control signals.

In the example of FIG. 2, the gas valve 156 of the welding-type power supply 102 is in fluid communication with the gas tank 106 through the gas regulator 109 (represented in FIG. 2 by arrow 109). In some examples, the power supply 102 controls a flow of gas from the gas tank 106 (and/or gas regulator 109) via the gas valve 156. In some examples, the power control circuitry 162 may control operation of the gas valve 156 via one or more signals. As shown, a gas output terminal 170 is in fluid communication with the gas valve 156.

In the example of FIG. 2, the power supply 102 is coupled to the wire feeder 200 via a fluid connection between the gas output terminal 170 of the power supply 102 and a gas input terminal 204 of the wire feeder 200. As shown, there is also a communication connection between the power communication terminal 152 of the power supply 102 and the feeder communication terminal 202 of the wire feeder 200. There is also an electrical connection between the power output terminal 168a of the power supply 102 and a power input terminal 206 of the wire feeder 200. Through these connections, the power supply 102 can send gas, power, and/or information to the wire feeder 200.

As shown, the wire feeder 200 includes a tool outlet 208 through which the wire feeder 200 can send shielding gas, welding-type output power, and/or welding wire 201 to the welding-type tool 108. As shown, the tool outlet 208 is coupled to the gas input terminal 204 and power input terminal 206, from/through which the gas and/or welding-type output power may be received at the tool outlet 208. The tool outlet 208 in turn connects to the conduit 107, which routes the gas, welding-type power, and welding wire 302 to the welding-type tool 108.

In some examples, the wire feeder 200 (and/or power supply 102 and/or remote device 199) may also send information to (and/or receive information from) the welding-type tool 108. For example, the welding-type tool 108 may be sent information regarding whether the supply of welding wire 201 has been exhausted, and the welding-type tool 108 may send a trigger signal when a trigger of the tool 108 is engaged. In some examples, communication between the tool 108 and the wire feeder 200 (and/or power supply 102 and/or remote device 199) may be wireless and/or through conduit 107.

In the example of FIG. 2, the welding wire 302 is supplied to the welding-type tool 108 from a wire spool 211 that is mounted on a spindle 210 of the wire feeder 200. As shown, the welding wire 201 is pulled from the spool 211 by feed rollers 212 of the wire feeder 200. Thereafter, the feed rollers 212 route the welding wire 302 to the tool outlet 208, conduit 107, and then welding-type tool 108.

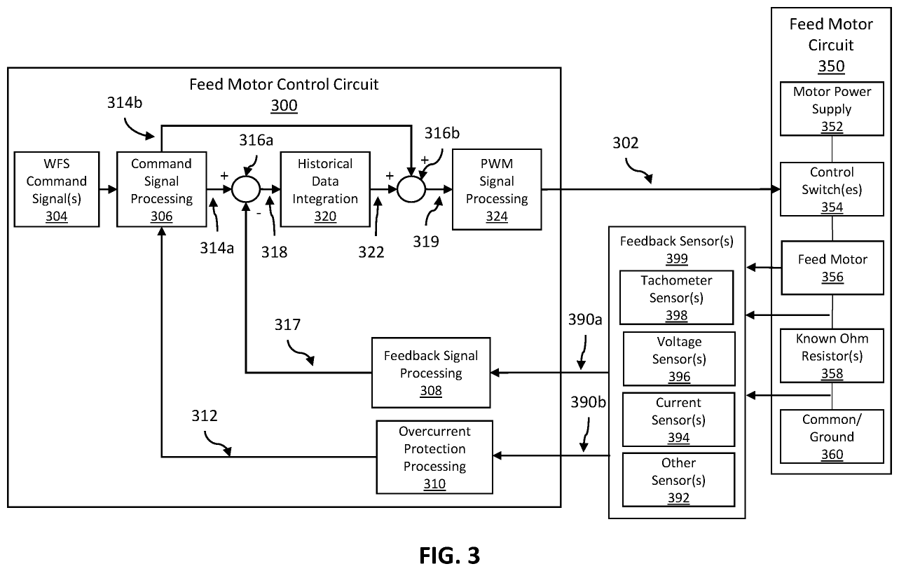

In the example of FIG. 2, the wire feeder 200 includes a feed motor 356 configured to actuate (e.g., rotate/turn) one or more of the feed rollers 212, to induce feeding of the welding wire 302. In some examples, the feed motor 356 may be a brushed direct current (DC) motor. As shown, feed motor 356 is part of a feed motor circuit 350 of the wire feeder 200. FIG. 2 additionally depicts one or more feedback sensors 399 in close proximity to the feed motor circuit 350. FIG. 3 shows additional detail of the feed motor circuit 350 and feedback sensors 399.

In the example of FIG. 2, the wire feeder 200 further includes a user interface (UI) 216, feeder communication circuitry 220, and feeder control circuitry 224. In some examples, the UI 216 may comprise user accessible input devices and/or output devices similar (or identical) to what is described above with respect to the OI 198. In some examples, the feeder communication circuitry 220 may be configured to facilitate communication (e.g., through the feeder communication terminal 202) via one or more wired protocols and/or wireless protocols, similar to what is described above with respect to the device communication circuitry 196. As shown, the UI 216, 216, feeder communication circuitry 220, feeder control circuitry 224, and feedback sensor(s) 399 are interconnected through a common electrical bus.

In some examples, the feeder control circuitry 224 may be configured to process inputs from the UI 216, feeder communication circuitry 220, and/or feedback sensor(s) 218. In some examples, the feeder control circuitry 224 may be configured to control operation of the feedback sensor(s) 218, feed motor 356, UI 216, and/or feeder communication circuitry 220.

In the example of FIG. 2, the feeder control circuitry 224 includes feeder processing circuitry 226, feeder memory circuitry 228, and a feed motor control circuit 300. In some examples, the feeder processing circuitry 226 may include one or more processors. In some examples, the feeder memory circuitry 228 may store machine-readable instructions configured for execution by the feeder processing circuitry 226. As shown, the feeder memory circuitry 228 includes an empty spool detection process 400, discussed further below.

While the feed motor control circuit 300 of the feeder control circuitry 224 is shown separate from the feeder processing circuitry 226 and feeder memory circuitry 228 for the sake of explanation, in some examples, the feed motor control circuit 300 may be part of, and/or include, the feeder control circuitry 226 and/or feeder memory circuitry 228. In some examples, the feed motor control circuit 300 may use one or more properties (e.g., rotation speed of the feed roller(s) 212 and/or feed motor 356, current through the feed motor 356, voltage across the feed motor 356, etc.) detected/measured by the feedback sensor(s) 399 to control the feed motor 356, protect the feed motor 356, and/or maintain a target wire feed speed. In some examples, one or more of the feedback sensor(s) 399 may be coupled to the feed motor circuit 350 and/or feed rollers 212 in order to detect and/or measure the one or more properties. In some examples, one or more of the properties detected/measured by the feedback sensor(s) 399, and/or one or more parameters of the feed motor control circuit 350, may also be used to determine whether the wire spool 211 has been emptied of welding wire 201.

FIG. 3 is a block diagram depicting example components of (and interactions between) the feed motor control circuit 300, feedback sensor(s) 399, and feed motor circuit 350. As shown, the feed motor circuit 350 includes a (e.g., DC) motor power supply 352 in series with one or more control switches 354, the feed motor 356, one or more resistors 358, and a common/ground potential 360. In some examples, the switch(es) 354 may comprise one or more relays and/or transistors (e.g., MOSFETs, JFETs, IGBTs, BJTs, etc.). In some examples, the resistor(s) 358 may have a known resistance. In some examples, the feed motor circuit 350 may additionally include one or more parallel branches (e.g., to shunt current around the feed motor 356 and/or resistor(s) 358 when the switch(es) 354 are open).

In the example of FIG. 3, the one or more feedback sensors 399 include one or more tachometer sensors 398, voltage sensors 396, current sensors 394, and/or other sensors 392. As shown, the one or more feedback sensors 399 interact with the feed motor circuit 350 to measure certain properties of the feed motor circuit 350, such as, for example, a rotation speed of the feed motor 356, an electrical current through the feed motor 356, and/or an electrical voltage across the feed motor 356. In some examples, the feedback sensor(s) 399 may additionally (or alternatively) interact with the feed roller(s) 212, such as, for example, to measure a rotation speed of the feed roller(s) 212.

In the example of FIG. 3, the one or more feedback sensors 399 provide one more feedback signals 390 to the feed motor control circuit 300. In some examples, the feedback signal(s) 390 may be representative of the one or more properties measured by the feedback sensor(s) 399. In some examples, the feed motor control circuit 300 may use the feedback signal(s) 390 to control the feed motor 356 and/or feed motor circuit 350.

In the example of FIG. 3, the feed motor control circuit 300 controls the feed motor 356 and/or feed motor circuit 350 through control signals 302 provided to the feed motor circuit 350. In particular, the feed motor control circuit 300 provides the control signals 302 to the control switch(es) 354 of the feed motor circuit 350. In some examples, the one or more control switches 354 are configured to open and/or close in response to (and/or depending on) the control signals 302.

In some examples, one or more of the control signals 302 may be pulse width modulated (PWM) control signals, and the one or more control switches 354 may be configured to open or close in response to one or more high amplitudes of the control signal(s) 302 (e.g., a pulse) or low amplitudes of the control signal(s) 302. In some examples, the state (e.g., on/closed or off/open) of the control switch(es) 354 may impact the supply of current through, and/or the voltage across the feed motor 356. In some examples, current may only flow through the feed motor 356 (thereby powering the feed motor 356) when the one or more control switches 354 are closed. Thus, the feed motor control circuit 300 can control the electrical power delivered the feed motor 356, and therefore the operation of the feed motor 356, by controlling the control switch(es) 354. While a simple feed motor circuit 350 is shown in the example of FIG. 3 for the sake of understanding, in some examples the feed motor circuit 350 may be more complex, with control of the one or more control switches 354 impacting more than simply when/whether current is supplied to the feed motor 356.

In the example of FIG. 3, the feed motor control circuit 300 uses the feedback signal(s) 390 in conjunction with one or more wire feed speed (WFS) command signals 304 (e.g., from the UI 216) to generate the control signals 302 used to control the control switch(es) 354. In some examples, the one or more WFS command signals 304 may be representative of a target wire feed speed (e.g., input by an operator into the UI 216). As shown, the feed motor control circuit 300 receives one or more WFS command signals 304 at a command signal processing module 306, while the feedback signals are received at a feedback signal processing module 308 and an overcurrent protection processing module 310. As shown, the command signal processing module 306 also receives one or more overcurrent feedback signal(s) 312 from the overcurrent protection processing module 310.

In some examples, the various modules of the feed motor control circuit 300 may be implemented using discrete circuitry (e.g., of the feeder processing circuitry 226) and/or software modules (e.g., represented by machine readable instructions stored in the feeder memory circuitry 228 and/or executed by feeder processing circuitry 226). In some examples, the command signal processing module 306 may perform certain processing operations on the WFS command signal(s) 304 (e.g., filtering, amplifying, converting, etc.). In some examples, the command signal processing module 306 may convert the WFS command signal(s) 304 into one or more different command signals that are representative of some parameter other than target WFS (e.g., target current, target voltage, etc.).

In some examples, the feedback signal(s) 390 received by the overcurrent protection processing module 310 may be directly representative of a current (e.g., through the feed motor 356 and/or resistor(s) 358). In some examples, the feedback signal(s) 390 received by the overcurrent protection processing module 310 may be representative of a voltage (e.g., across the feed motor 356 and/or resistor(s) 358) and the overcurrent protection processing module 310 may determine the current using the voltage and a known resistance of the resistor 358 (e.g., stored in feeder memory circuitry 228). In some examples, the overcurrent protection processing module 310 may compare the received/determined current to a threshold value (e.g., stored in feeder memory circuitry 228) to determine whether too much current is being supplied to the feed motor 356 (e.g., as may happen if welding wire 201 gets tangled, the feed motor 356 gets a short, etc.).

In some examples, the overcurrent protection processing module 310 may provide one or more overcurrent feedback signal(s) 312 representative of an overcurrent condition if the amount of electrical current supplied to the feed motor 356 exceeds the threshold value. As discussed above, and shown in FIG. 3, the command signal processing module 306 receives the overcurrent feedback signal(s) 312 from the overcurrent protection processing module 310. In some examples, the command signal processing module 306 may modify the WFS command signal(s) 304 based on the overcurrent feedback signal(s) 312, such as, for example, by setting the commanded WFS to zero, or lowering the represented WFS by a set amount, or to a set amount (e.g., stored in feeder memory circuitry 228).

In the example of FIG. 3, the command signal processing module 306 outputs one or more processed command signals 314 (e.g., representative of one or more results of the processing discussed above). As shown, the one or more processed command signals 314 are received by a first summing module 316a (e.g., operational amplifier), along with one or more processed feedback signals 317 provided by the feedback signal processing module 308.

In some examples, the feedback signal processing module 308 may perform certain processing operations on the feedback signal(s) 390 (e.g., filtering, amplifying, converting, etc.). In some examples, the feedback signal processing module 308 may convert the feedback signal(s) 390 received from the feedback sensor(s) 399 into one or more different signals that are representative of some other property (e.g., current, voltage, WFS, etc.) that is different than the original property of the feed motor circuit 350. In the example of FIG. 3, the feedback signal processing module 308 outputs one or more processed feedback signals 317 (e.g., representative of one or more results of the processing discussed above) to the first summing module 316a.

In the example of FIG. 3, the first summing module 316a receives the processed feedback signal(s) 317 at a negative terminal of the first summing module 316a, and receives the processed command signal(s) 314a at a positive terminal of the first summing module 316a (though, in some examples, these polarities may be reversed). As shown, the first summing module 316a outputs one or more error signals 318. In some examples, the error signal(s) 318 output by the first summing module 316a may be representative of the sum of (and/or difference between) the processed feedback signal(s) 317 and processed command signal(s) 314a.

In the example of FIG. 3, the one or more error signals 318 are received by a historical data integration module 320. In some examples, the historical data integration module 320 may keep a historical record of past error signals 318 (e.g., via the feeder memory circuitry 228) and modify the error signal(s) 318 based on this historical record. As shown, the historical data integration module 320 outputs one or more processed first error signals 322 (e.g., representative of one or more results of the historical integration/modification discussed above) to a second summing module 316b.

In the example of FIG. 3, the second summing module 316b receives the processed first error signal(s) 318 at a first positive terminal of the second summing module 316b, and receives the processed command signal(s) 314b at a second positive terminal of the second summing module 316b. As shown, the second summing module 316b outputs one or more summation signals 319. In some examples, the summation signal(s) 319 output by the second summing module 316b may be representative of the sum of the processed first error signal(s) 318 and the processed command signal(s) 314b.

In the example of FIG. 3, the summation signal(s) 319 output by the second summing module 316b are received at a PWM signal processing module 324. In some examples, the PWM signal processing module 324 may generate one or more control signals 302 based on the summation signal(s) 319. In some examples, the control signal(s) 302 output by the PWM signal processing module 324 may comprise one or more PWM signals, having one or more PWM duty cycles. In some examples, the PWM duty cycle(s) of the control signal(s) may impact the operation of the control switch(es) 354, and thereby impact the operation of the feed motor 356. For example, a higher PWM duty cycle may result in the control switch(es) 354 being on/closed for longer periods of time, and/or result in more current/voltage being supplied to/across the feed motor 356. In some examples, the PWM signal processing module 324 may determine an operation of the feed motor circuit 350 (and/or feed motor 356) that will result in a future iteration of the error signal(s) 318 being closer to zero, and generate the control signal(s) 302 based on this determination (e.g., to achieve the determined operation).

In some examples, the current supplied to the feed motor 356 may be directly proportional to a torque of the feed motor (all else being equal), while the voltage across the feed motor 356 may be directly proportional to a rotational speed of the feed motor 356 (all else being equal). Thus, in some examples, if the control signal(s) 302 control the control switch(es) 354 to provide more current/voltage, the feed motor 356 may induce more torque/speed to the feed roller(s) 212. In some examples, a change in current/voltage/WFS may result in change in the measurements of the feedback sensor(s) 399, which may in turn change the feedback signal(s) 390, which may in turn change the error signal(s) 318 to be closer to zero (e.g., when attempting maintaining a steady WFS).

In some examples, by continually adjusting the feed motor circuit 350 according to the error signal(s) 318, the feeder control circuitry 224 (and/or feed motor control circuit 300) of the wire feeder 200 can maintain an approximately constant rotational speed of the feed roller(s) 212. Maintaining an approximately constant rotational speed of the feed roller(s) 212 may effectively maintain an approximately constant WFS (e.g., at or close to a commanded WFS) when welding wire 201 is moving through the feed roller(s) 212, which can be important for weld quality.

However, when a supply of welding wire 201 on the wire spool 211 is extinguished, and welding wire 201 is no longer moving through the feed roller(s) 212, the wire feeder 200 (and/or feed motor control circuit 300) can no longer regulate WFS. Even though the wire feeder 200 (and/or feed motor control circuit 300) may continue to strive to maintain an approximately constant rotational speed of the feed roller(s) 212 (e.g., to achieve a commanded WFS), rotational speed of the feed roller(s) 212 no longer translates to (and/or impacts) WFS when there is no welding wire 201 moving through the feed roller(s) 212.

In some examples, when the welding wire 201 initially runs out and/or no longer moves through the feed roller(s) 212, the torque needed to maintain an approximately constant rotational speed of the feed roller(s) 212 decreases quickly and substantially. Because the current used by a brushless DC motor (e.g., the feed motor 356) is proportional to the torque provided by the motor, a drop in required torque may result in a corresponding drop in required current. Thus, the feed motor 356 may receive an excess supply of current when the welding wire 201 initially runs out and/or no longer moves through the feed roller(s) 212.

In some examples, excess current supplied to the feed motor 356 may translate into excess rotational speed of the feed motor 356 (and/or feed roller(s) 212). The excess rotational speed of the feed motor 356 (and/or feed roller(s) 212) may translate into an abnormally large (or small, depending on polarity) error signal 318 and/or an abnormally large (or small) PWM duty cycle.

Thus, in some examples, the current measured by the feedback sensor(s) 399 (and/or determined by the feedback signal processing module 308 and/or overcurrent protection processing module 310) may be used as a proxy for torque and/or for identifying when a wire spool 211 is empty of welding wire 201. Likewise, the error signal(s) 318 and/or the (e.g., PWM duty cycle(s) of the) control signal(s) 302 generated by the feed motor control circuit 300 may be used to identify when a wire spool 211 is empty of welding wire 201. In some examples, applied voltage (e.g., across the feed motor 356) may also be used to identify when a wire spool 211 is empty of welding wire 201.

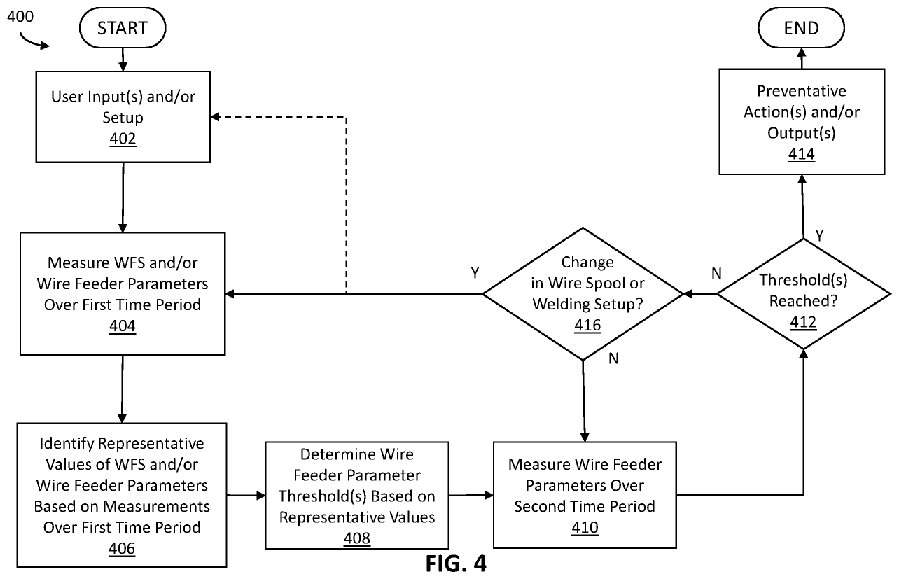

FIG. 4 is a flow diagram illustrating an example operation of the empty spool detection process 400. The empty spool detection process 400 is illustrated as stored in feeder memory circuitry 228, power memory circuitry 166, and device memory circuitry 190 in FIG. 2 to indicate that portions of the empty spool detection process 400 may be performed and/or executed by one, or several, of the wire feeder 200, power supply 102, and/or remote device 199. As such, some of the disclosure below may generally refer to control circuitry, processing circuitry, and/or memory circuitry as shorthand for feeder control circuitry 224, feeder processing circuitry 226, and/or feeder memory circuitry 228; device control circuitry 194, device processing circuitry 192, and/or device memory circuitry 190; and/or power control circuitry 162, power processing circuitry 164, and/or power memory circuitry 166.

In some examples, the empty spool detection process 400 may be implemented via machine-readable instructions stored in memory circuitry. Though illustrated as being stored in memory circuitry, in some examples the empty spool detection process 400 may alternatively, or additionally, be implemented via discrete circuitry (e.g., of the control circuitry). In some examples, the empty spool detection process 400 may be executed as part of, or in parallel with, a larger welding-type process.

In the example of FIG. 4, the empty spool detection process 400 begins at block 402 where a user provides one or more inputs and/or performs one or more setup operations. In some examples, the input(s) may be provided via the UI 216 of the wire feeder 200, the HMI 158 of the power supply 102, and/or the OI 198 of remote device 199. In some examples, the user input(s) may include, for example, a type of welding-type process, type of welding-type operation, material of workpiece 112, positioning of workpiece 112, type of welding-type tool 108, gas type, size of wire spool 211, brand of wire spool 211, identifier of wire spool 211, type of welding wire 201, identifier of welding wire 201, type of feed motor 356, threshold information, and/or other relevant information. In some examples, the setup operations may include installation of a spool 211 on the spindle 210, initial routing of welding wire 201 from the spool 211 to the feed rollers 212, and/or indicating that a new spool 211 has been installed.

In the example of FIG. 4, the empty spool detection process 400 proceeds to block 404 after block 402, where the processing circuitry monitors and/or records (e.g., in memory circuitry) WFS and/or certain parameters of the wire feeder 200 that may be useful in determining when the spool 210 is empty of welding wire 201. Such wire feeder parameters may include, for example, current through feed motor 356, rate of change of current through feed motor 356, voltage across the feed motor 356, rate of change of voltage across the feed motor 356, the error signal(s) 318, the rate of change of error signal(s) 318, PWM duty cycles, and/or rate of change of PWM duty cycles. In some examples, the processing circuitry may monitor and/or record a magnitude (and/or absolute value) of the WFS and/or wire feeder parameter value(s), such as, for example, to account for potential differences in convention and/or polarity.

In some examples, block 404 may occur over a certain time period, such as, for example, a steady state time period where the WFS is approximately (e.g., within 5 or 10%) constant. In some examples, block 404 may occur in response to some input (e.g., provided via the UI 216, HMI 158, and/or OI 198). In some examples, block 404 may occur a certain time duration after a welding operation is begun, and/or for a time duration, that corresponds to a duration stored in memory circuitry and/or received as an input (e.g., via the UI 216, HMI 158, and/or OI 198).

In some examples, the processing circuitry may monitor the WFS and/or wire feeder parameters using a low pass filter. In some examples, the feed motor control circuit 300 and/or feedback sensor(s) 399 may operate on a very high frequency, which may result in substantial noise and/or fluctuations. While such high frequency operation may be helpful for the purposes of control of the feed motor circuit 350, a lower frequency monitoring (e.g., smoothing out the noise/fluctuations) may be more useful for the purposes of block 404.

In the example of FIG. 3, the empty spool detection process 400 proceeds to block 406 after block 404, where the processing circuitry identifies one or more representative values of the WFS and/or wire feeder parameter values based on the measurements and/or monitoring of block 404. In some examples, the processing circuitry may make a statistical analysis of the measurements made at block 404 to identify the representative value(s), such as, for example, through calculations of average, standard deviation, mode, distribution curves, etc. In some examples, this statistical analysis may be less helpful where certain wire feeder parameters are concerned (e.g., because the average representative value of an error signal 318, rate of change of voltage, and/or rate of change of current, should be approximately zero at steady state).

In the example of FIG. 3, the empty spool detection process 400 proceeds to block 408 after block 406, where the processing circuitry identifies one or more wire feeder parameter thresholds based on the representative values determined at block 406. For example, the threshold(s) might be offset from the representative value(s) by a certain set amount and/or percentage (e.g., stored in memory circuitry). As another example, the stored/preset (and/or dynamically determined) threshold(s) might be scaled and/or shifted upwards or downwards based on the commanded (and/or monitored) WFS.

In some examples, the wire feeder parameter threshold(s) may be used to determine if/when a wire feeder parameter value is indicative of an empty wire spool 211. In some examples, it may be helpful to base the threshold(s) on (e.g., steady state) representative values, rather than using hard coded one size fits all threshold values, to account for the impact of different operational parameters (e.g., type of welding-type process, type of welding-type operation, material of workpiece 112, positioning of workpiece 112, type of welding-type tool 108, gas type, size of wire spool 211, brand of wire spool 211, identifier of wire spool 211, type of welding wire 201, identifier of welding wire 201, type of feed motor 356, tension of rollers 212, tension of spool 210, etc.). Nevertheless, in some examples (e.g., where there is too little time), blocks 404-406 may be skipped and hard coded threshold values selected at block 408.

In the example of FIG. 4, the empty spool detection process 400 proceeds to block 410 after block 408, where the processing circuitry monitors and/or records (e.g., in memory circuitry) values corresponding to the wire feeder parameters over a second time period. In some examples, the second time period may be a shorter time period than the first time period of block 404.

Like in the first time period of block 404, in some examples, the processing circuitry may monitor and/or record a magnitude (and/or absolute value) of the value(s) at block 410. Like the first time period of block 404, the duration of the second time period of block 410 may correspond to a duration stored in memory circuitry and/or input (e.g., via the UI 216, HMI 158, and/or OI 198). Also like the first time period of block 404, the processing circuitry may monitor the feedback values corresponding to the empty spool indicators using a low pass filter at block 410.

In the example of FIG. 4, the empty spool detection process 400 proceeds to block 412 after block 410, where the processing circuitry compares the wire feeder parameters monitored and/or recorded at block 410 to the threshold(s) determined at block 408. As shown, the empty spool detection process 400 proceeds from block 412 to block 414 if one or more of the wire feeder parameter values reach (and/or cross) the determined threshold(s). In some examples, the empty spool detection process 400 only proceeds to block 414 if all of the wire feeder parameter values reach (and/or cross) their corresponding thresholds. In some examples, the empty spool detection process 400 only proceeds to block 414 if some set amount or percentage (e.g., stored in memory circuitry) of the wire feeder parameter values reach (and/or cross) their corresponding thresholds.

In the example of FIG. 4, the processing circuitry takes one or more preventative actions, and/or provides one or more outputs, at block 414. For example, the processing circuitry may output a notification (e.g., via the UI 216, HMI 158, and/or OI 198) indicating that the wire spool 211 is out of welding wire 201. As another example, the processing circuitry may disable and/or prevent further welding-type operations until the welding wire 201 is replenished (e.g., via a new wire spool 211). For example, the processing circuitry may ignore trigger signals sent by the welding-type tool 108 and/or disable the power conversion circuitry 160. In this way, the operator may be alerted to the issue before there is substantial negative impact.

In the example of FIG. 4, the empty spool detection process 400 proceeds to block 416 after block 410, where the processing circuitry determines whether there has been some change warranting return to block 402 and/or block 404. Such a situation might occur if, for example, there has been a change in some operational and/or setup information (e.g., input at block 402), some change in the welding wire 201 and/or wire spool 211, and/or some other change that might impact the empty spool detection process 400. If so, the empty spool detection process 400 returns to block 402 and/or block 404, as shown. Otherwise, the empty spool detection process 400 returns to block 410 to continue monitoring the wire feeder parameters.

The disclosed welding system 100 and/or empty spool detection process 400 automatically detects and/or determines when a wire spool 211 is emptied of welding wire 201. This may help to alert the operator to potential issues that might negatively impact the welding-type operation. Such an alert may be particularly helpful in push/pull systems, where additional “pull” feed rollers in the welding tool may continue feeding welding wire even when the wire spool is out of welding wire. Furthermore, the system performs the detection function using wire feeder parameters that are already relied upon for control and/or protection of the feed motor 356, thereby omitting the need for extra (and/or expensive) components, and making the system efficient, cost effective, and competitive.

The present methods and systems may be realized in hardware, software, and/or a combination of hardware and software. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine-readable storage media and to exclude propagating signals.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As used herein, the terms “approximate” and/or “approximately,” when used to modify or describe a value (or range of values), position, shape, orientation, and/or action, mean reasonably close to that value, range of values, position, shape, orientation, and/or action. Thus, the examples described herein are not limited to only the recited values, ranges of values, positions, shapes, orientations, and/or actions but rather should include reasonably workable deviations.

As utilized herein, the terms “e.g.,” and “for example” set off lists of one or more non-limiting examples, instances, or illustrations.

As used herein, the terms “couple,” “coupled,” “attach,” “attached,” “connect,” and/or “connected” refer to a structural and/or electrical affixing, joining, fasten, linking, and/or other securing.

As utilized herein the terms “circuits” and “circuitry” refer to physical electronic components (i.e. hardware) and/or any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

As utilized herein, circuitry is “configured” to perform a function whenever the circuitry comprises the necessary hardware and code (if any is necessary) to perform the function, regardless of whether performance of the function is disabled or not enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC). The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type power refers to power suitable for welding, cladding, brazing, plasma cutting, induction heating, CAC-A and/or hot wire welding/preheating (including laser welding and laser cladding), carbon arc cutting or gouging, and/or resistive preheating.

As used herein, a welding-type power supply and/or power source refers to any device capable of, when power is applied thereto, supplying welding, cladding, brazing, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, a welding-type tool refers to any tool capable of performing a welding, cladding, brazing, plasma cutting, induction heating, carbon arc cutting or gouging and/or resistive preheating operation.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

While the present method and/or system has been described with reference to certain implementations, it will be understood by those skilled in the art that various changes may be made and equivalents may be substituted without departing from the scope of the present method and/or system. For example, blocks and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding system, comprising:
a wire feeder, comprising:
a spindle configured to retain a wire spool,
a feed roller configured to pull a welding wire from the wire spool and feed the welding wire to a welding tool during a welding operation, and
a feed motor configured to rotate the feed roller; and
control circuitry configured to:
monitor a current magnitude of an electrical current supplied to the feed motor, a current magnitude rate of change of the current magnitude, an error signal magnitude of an error signal used to control the electrical current supplied to the feed motor, or an error signal magnitude rate of change of the error signal magnitude,
compare the current magnitude, the current magnitude rate of change, the error signal magnitude, or the error signal magnitude rate of change to a threshold, and
in response to the current magnitude, or the current magnitude rate of change, falling below the threshold, or the error signal magnitude, or the error signal magnitude rate of change, rising above the threshold, output a notification or disable the welding operation.

2. The welding system of claim 1, wherein the notification indicates that the welding wire has run out, and the notification is delivered via an interface of: the wire feeder, a welding-type power supply in communication with the wire feeder, the welding tool, or a remote device in communication with the wire feeder or the welding-type power supply.

3. The welding system of claim 1, wherein the control circuitry is further configured to:
monitor the current magnitude, or the error signal magnitude rate of change, over a time period of the welding operation or a prior welding operation,
identify a representative electrical current, or a representative rate of change of the error signal, based on the current magnitude, or the error signal magnitude rate of change, monitored over the time period, and
determine the threshold based on the representative electrical current or the representative rate of change of the error signal.

4. The welding system of claim 1, wherein the control circuitry is configured to control the electrical current supplied to the feed motor based on a target wire feed speed and the error signal.

5. The welding system of claim 4, wherein the control circuitry is configured to determine the threshold based on the target wire feed speed.

6. The welding system of claim 1, wherein the control circuitry is configured to control the electrical current supplied to the feed motor based on a target wire feed speed and the error signal, the error signal being generated based on the target wire feed speed and a feedback signal.

7. The welding system of claim 1, wherein monitoring the current magnitude of the electrical current supplied to the feed motor comprises monitoring a duty cycle of a pulse width modulation (PWM) signal used to control the electrical current supplied to the feed motor, or monitoring the current magnitude rate of change comprises monitoring a duty cycle rate of change of the duty cycle.

8. The welding system of claim 1, wherein the control circuitry is configured to monitor the current magnitude of the electrical current supplied to the feed motor using a low pass filtered version of a motor current feedback signal, and output the notification or disable the welding operation in response to the current magnitude falling below the threshold.

9. The welding system of claim 8, wherein the control circuitry is further configured to:
identify a representative electrical current supplied to the feed motor using the low pass filtered version of the motor current feedback signal, and
determine the threshold based on the representative electrical current.

10. The welding system of claim 1, wherein the control circuitry is configured to monitor the error signal magnitude, and output the notification or disable the welding operation in response to the error signal magnitude rising above the threshold.

11. A method, comprising:
retaining a wire spool on a spindle of a wire feeder;
rotating a feed roller of the wire feeder, via a feed motor of the wire feeder;
pulling a welding wire from the wire spool and feeding the welding wire to a welding tool during a welding operation, via the feed roller;
monitoring, via control circuitry, a current magnitude of an electrical current supplied to the feed motor, a current magnitude rate of change of the current magnitude, an error signal magnitude of an error signal used to control the electrical current supplied to the feed motor, or an error signal magnitude rate of change of the error signal magnitude;
comparing the current magnitude, the current magnitude rate of change, the error signal magnitude, or the error signal magnitude rate of change to a threshold, via the control circuitry; and
in response to the current magnitude, or the current magnitude rate of change, falling below the threshold, or the error signal magnitude, or the error signal magnitude rate of change, rising above the threshold, outputting a notification or disabling the welding operation, via the control circuitry.

12. The method of claim 11, wherein the notification indicates that the welding wire has run out, and the notification is delivered via an interface of: the wire feeder, a welding-type power supply in communication with the wire feeder, the welding tool, or a remote device in communication with the wire feeder or the welding-type power supply.

13. The method of claim 11, further comprising:
monitoring, via the control circuitry, the current magnitude, or the error signal magnitude rate of change, over a time period of the welding operation or a prior welding operation;
identifying, via the control circuitry, a representative electrical current, or a representative rate of change of the error signal, based on the current magnitude, or the error signal magnitude rate of change, monitored over the time period, and
determining, via the control circuitry, the threshold based on the representative electrical current or the representative rate of change of the error signal.

14. The method of claim 11, further comprising controlling, via the control circuitry, the electrical current supplied to the feed motor based on a target wire feed speed and the error signal.

15. The method of claim 14, further comprising determining, via the control circuitry, the threshold based on the target wire feed speed.

16. The method of claim 11, further comprising controlling, via the control circuitry, the electrical current supplied to the feed motor based on a target wire feed speed and the error signal, the error signal being generated based on the target wire feed speed and a feedback signal.

17. The method of claim 11, wherein monitoring the current magnitude of the electrical current supplied to the feed motor comprises monitoring a duty cycle of a pulse width modulation (PWM) signal used to control the electrical current supplied to the feed motor, or monitoring the current magnitude rate of change comprises monitoring a duty cycle rate of change of the duty cycle.

18. The method of claim 11, wherein the current magnitude of the electrical current supplied to the feed motor, or the current magnitude rate of change, is monitored using a low pass filtered version of a motor current feedback signal, and the notification is output, or the welding operation disabled, in response to the current magnitude or the current magnitude rate of change falling below the threshold.

19. The method of claim 18, wherein the control circuitry monitors the current magnitude rate of change, and outputs the notification or disables the welding operation in response to the current magnitude rate of change falling below the threshold.

20. The method of claim 11, wherein the control circuitry monitors the error signal magnitude rate of change, and outputs the notification or disables the welding operation in response to the error signal magnitude rate of change rising above the threshold.
